(19) United States
(12) Patent Application Publication
(10) Pub. No.: US 2013/0109816 A1
(43) Pub. Date: May 2, 2013

(54) PROCESSES FOR REMOVING SULFUR-CONTAINING END GROUPS FROM POLYMERS

(71) Applicants: WILLIAM BROWN FARNHAM, Hockessin, DE (US); Michael Feyd, Philadelphia, PA (US); Michael Thomas Sheehan, Corpus Christi, TX (US)

(72) Inventors: WILLIAM BROWN FARNHAM, Hockessin, DE (US); Michael Feyd, Philadelphia, PA (US); Michael Thomas Sheehan, Corpus Christi, TX (US)

(73) Assignee: E.I. DU PONT DE NEMOURS AND COMPANY, Wilmington (DE)

(21) Appl. No.: 13/283,675

(22) Filed: Oct. 28, 2011

(51) Int. Cl. C08F 112/08; C08F 212/08

(52) U.S. Cl. 525/451; 525/535

(57) ABSTRACT

This invention provides a method for removing certain sulfur-containing end groups from polymers, especially those made via RAFT polymerization processes. A solution of radical initiator is used in the method to accomplish removal of the certain sulfur-containing end groups.

### FIELD OF THE INVENTION

This invention provides a method for removing certain sulfur-containing end groups from polymers, especially those made via RAFT polymerization processes.

### BACKGROUND

There is increasing interest in developing polymerization processes that can be predictably controlled to produce polymers having specifically desired structures and predictable, narrow dispersity molecular weights. One of the means for achieving such results is through a process of living polymerization. Such a process provides a higher degree of control during the synthesis of polymers having predictably well-defined structures and properties as compared to polymers made by conventional polymerization processes.

Controlled radical polymerization processes such as RAFT (reversible addition fragmentation chain transfer) provide useful embodiments of living polymerization processes. RAFT processes using xanthate or dithiocarbamate chain transfer RAFT agents are disclosed in WO 99/31144. RAFT processes using dithioester or trithiocarbonate chain transfer agents are disclosed in WO 98/01478, WO 200500319, WO 2005000924 and WO 2005000923.

The polymers produced by RAFT processes have end groups derived from the chain transfer agents used in these processes. For RAFT-derived polymers using xanthate, dithiocarbamate, dithioester or trithiocarbonate chain transfer agents, each polymer chain will contain at least one end group comprising a xanthate, dithiocarbamate, dithioester or trithiocarbonate functional group. In some end-use applications of the RAFT-derived polymers, it may be desirable to remove these functional groups and replace them with hydrogen.

WO 02/090397 discloses a process for substituting a dithiocarbonylated or dithiophosphorylated function on the chain end of a living organic polymer with a hydrogen atom by contacting the polymer with a source of free radicals and an organic compound bearing a labile hydrogen atom.

WO2005000923, WO2005003192, WO2008/103144, U.S. Pat. No. 7,012,119, U.S. Pat. No. 6,988,439, and U.S. Pat. No. 7,807,755 disclose several methods for removing the sulfur-containing portion of a RAFT chain transfer agent from the polymer terminal end.

G. Moad et al. (Polym. Int. 2011; 60, 9-25), H. Willcock et al. (Polym. Chem., 2010, 1, 149-157) and A. O. Moughton et al. (Soft Matter, 2009, 5, 2361-2370) disclose replacing thiocarbonylthio end groups of RAFT polymers with hydrogen, using radical initiators and a hydrogen donor.

There remains a need for a RAFT end-group removal process that can be carried out on a RAFT polymer and minimizes coupling and disproportionation reactions.

### SUMMARY

One aspect of this invention is a process comprising:
a) forming a homogeneous solution comprising:
   i) a first solvent;
   ii) a salt of hypophosphorous acid, M+H₂PO₂, wherein M⁺ is a protonated nitrogen base or tetra-alkyl ammonium;
   iii) 25-80 wt % of a polymer comprising a sulfur-containing functional group, —CHY—SC(S)X or —C(Me)Z—SC(S)X,
   wherein the wt % polymer is based on the combined weight of the polymer and the first solvent, and
   wherein
      X is R, OR¹, N(R²)₂, SR³, or P(O)(OR⁴)₂;
      Y is —CN, aryl, carboxyl, or C(O)NHR⁵;
      Z is —CN, carboxyl, or C(O)NHR⁵;
      R is substituted or unsubstituted C₁-C₂₅ alkyl; substituted or unsubstituted C₂-C₂₅ alkenyl; substituted or unsubstituted C₂-C₂₅ alkynyl; substituted or unsubstituted phenyl; substituted or unsubstituted naphthyl; and substituted or unsubstituted benzyl; R¹, R², R³, and R⁴ are substituted or unsubstituted C₁-C₂₅ alkyl; substituted or unsubstituted C₆-C₁₀ aryl; a 3- to 8-membered carbocyclic or heterocyclic ring, or N(R²)₂ is a 3- to 8-membered heterocyclic ring; and R⁵ is C₁-C₆ alkyl or substituted alkyl; and
   iv) a radical initiator;
b) heating the homogeneous solution to a reaction temperature for a sufficient time to replace the —SC(S)X groups of the functional groups by —H; and
wherein the radical initiator has a half-life of more than 2 hours at the reaction temperature and the molar ratio of radical initiator to sulfur-containing functional group is 1:1 or less.

Another aspect of this invention is a process comprising:
a) forming a homogeneous solution comprising:
   i) a first solvent;
   ii) a salt of hypophosphorous acid, M+H₂PO₂, wherein M⁺ is a protonated nitrogen base or tetra-alkyl ammonium;
   iii) 25-80 wt % of a polymer comprising a sulfur-containing functional group, —CHY—SC(S)X or —C(Me)Z—SC(S)X,
   wherein the wt % polymer is based on the combined weight of the polymer and the first solvent, and
   wherein
      X is R, OR¹, N(R²)₂, SR³, or P(O)(OR⁴)₂;
      Y is —CN, aryl, carboxyl, or C(O)NHR⁵;
      Z is —CN, carboxyl, or C(O)NHR⁵;
      R is substituted or unsubstituted C₁-C₂₅ alkyl; substituted or unsubstituted C₂-C₂₅ alkenyl; substituted or unsubstituted C₂-C₂₅ alkynyl; substituted or unsubstituted phenyl; substituted or unsubstituted naphthyl; and substituted or unsubstituted benzyl; R¹, R², R³, and R⁴ are substituted or unsubstituted C₁-C₂₅ alkyl; substituted or unsubstituted C₆-C₁₀ aryl; a 3- to 8-membered carbocyclic or heterocyclic ring, or N(R²)₂ is a 3- to 8-membered heterocyclic ring; and R⁵ is C₁-C₆ alkyl or substituted alkyl;
b) adding a radical initiator to the homogeneous solution,
c) heating the homogeneous solution to a reaction temperature for a sufficient time to replace the —SC(S)X groups of the functional groups by —H; and
wherein the radical initiator is added to the homogeneous solution over a period of at least 3 half-lives at the reaction temperature and wherein the molar ratio of radical initiator to sulfur-containing functional group is 1:1 or less.

### BRIEF DESCRIPTION OF THE FIGURES

FIG. 1 is a graph of absorbance vs wavelength for the 3400 Mw polystyrene-ttc of Example 1, and shows the large absorbance peak at A₃₁₂, due to the presence of trithiocarbonate end groups.

FIG. 2 is a graph of absorbance vs wavelength for the 3400 Mw polystyrene-ttc of Example 1 after the removal of the trithiocarbonate end groups from the polymer.

FIG. 3 is a graph of the molecular weight distribution of the 3400 Mw polystyrene polymer of Example 1 before and after the removal of the trithiocarbonate end groups.

FIG. 4 is a graph of the molecular weight distribution of the 7500 Mw polystyrenes produced by the processes described in Example 2 and Comparative Example A.

FIG. 5 is a graph of the molecular weight distribution of the 22000 Mw polystyrenes produced by the processes described in Example 3 and Comparative Examples B-E.

FIG. 6 is an overlay of the SEC traces of the polymers of Example 4 and that of Example 3.

FIG. 7 is an overlay of the SEC traces of the polymers of Example 5 and that of Example 4.

FIG. 8 is a graph of the molecular weight distribution of the 14600 Mw polymethylmethacrylates of Example 6, before and after precipitation to remove lower molecular weight material.

FIG. 9 is a graph of the thermogravimetric analysis (TGA) of the 25000 Mw polymethylmethacrylate of Example 7.

FIG. 10 is a graph of the molecular weight distribution of the 25000 Mw polymethylmethacrylates of Example 7 and Comparative Example G.

FIG. 11 is a graph of the thermogravimetric analysis (TGA) of the 25000 Mw polymethylmethacrylate of Comparative Example G.

### DETAILED DESCRIPTION

As used herein, a radical initiator is a substance that can produce radical species under mild conditions and promote radical reactions. Typical examples include peroxides and azo compounds.

A nitrogen base is a basic compound that contains nitrogen.

A random copolymer is a copolymer having macromolecular chains in which the probability of finding a given monomeric unit at any given site in the chain is independent of the nature of the adjacent units.

A block copolymer is a polymer having 2 or more differing homopolymer or copolymer segments attached to each other such that the end of one segment is attached to the beginning of the next.

A graft copolymer is a homopolymer or copolymer segment (backbone) to which are attached, at varying or uniform distances along its length, one or more homopolymer or copolymer segments (grafts) that may be different from or the same as the backbone.

A gradient copolymer is a copolymer of two or more monomers, where the chemical composition changes continuously and predictably along the polymer chain.

A (meth)acrylate refers to the corresponding methacrylate or acrylate compounds, and (meth)acrylamide refers to the corresponding methacrylamide or acrylamide compounds.

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, “a” or “an” are employed to describe elements and components of the invention. This description should be read to include one, or at least one, and the singular also includes the plural unless it is obvious that it is meant otherwise.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Many of the chain transfer agents used in RAFT polymerization processes leave at least one sulfur-containing end-group on the RAFT-derived polymer. Typically, the sulfur-containing end-group has the structure —SC(S)X, where X is an alkyl, aryl, alkoxy, amine or alkylthio group. In some end-use applications of the RAFT polymer, the sulfur-containing end-group can be left in place. In other end-use applications, it is desirable to remove the sulfur-derived end-group and replace it with a hydrogen atom. Similarly, it may be desirable to remove sulfur-containing groups that are in the polymer backbone or sulfur-containing functional groups pendant from the main chain.

The present invention is directed to processes for removing one or more groups of the formula —SC(S)X from a polymer containing such groups. Successful controlled removal of such sulfur-containing groups produces a number of significant advantages. Removal of the end group eliminates the odor characteristic of these species or degradation products derived from them. It also removes the strong color often associated with some of those end groups. The color removal is desirable for applications that require a clear, colorless film. It also eliminates the strong absorption that may interfere with applications that require UV or IR transparency.

In an embodiment, removal of the —SC(S)X groups is accomplished by dissolving the polymer and a hydrogen atom donor in a suitable solvent and adding a solution of a radical initiator to a stirred (agitated) mixture of the polymer and hydrogen atom donor. Unwanted coupling reactions, i.e., reactions involving two or more polymer chains to form a higher molecular weight polymer, are minimized by conducting the reaction at high polymer loadings. Unwanted couplings are also minimized by maintaining a low concentration of radicals in the solution. Isolation of the reduced polymer (i.e., the polymer that is essentially free of —SC(S)X groups or reaction by-products) can then be accomplished by any of several conventional methods.

Suitable first solvents for use in the processes of the present invention are capable of dissolving the polymer at high solids loading, e.g., at 25-80 wt % based on the combined weight of the polymer and the first solvent, and the hydrogen atom donor at loadings of 2-15 wt %, based on the combined weight of the polymer, the first solvent and the hydrogen atom donor. The solvent should also be inert under the reaction conditions and not react with the polymer, the hydrogen donor, the radical initiator, the radicals formed or any reaction by-products.

Dissolving the polymer at such high solids loadings is facilitated by selecting a solvent that has a solubility parameter within two units (unit=δ(cal/cm³)^{1/2}) of the solubility parameter of the polymer. Solubility parameters of a wide variety of polymers and solvents have been published, or can be determined by well-established methods. Typically, hydrophobic polymers have solubility parameters in the range of 6-8, and hydrophilic polymers have solubility parameters greater than 12.

Suitable first solvents include acetone, acetonitrile, amyl acetate, butyl acetate, butyl alcohol, diethyl carbonate, di(ethylene glycol), di(ethylene glycol)monobutyl ether, di(ethylene glycol)monomethyl ether, diethyl ketone, DMAC(N,N-dimethylacetamide), N,N-dimethylformamide, dimethyl sulfoxide, 1,4-dioxane, ethyl acetate, ethylene carbonate, ethylene glycol, ethylene glycol diacetate, isopropyl alcohol, methyl amyl ketone, MPK (methyl propyl ketone), MEK (methyl ethyl ketone), propyl acetate, 1,2-propylenecarbonate, THF (tetrahydrofuran), PGME (polyglycol methyl ether) and mixtures thereof.

In the processes of the present invention, the reducing agent is a hydrogen donor and is typically a salt of a hypophosphorous acid, M+H₂PO₂—, wherein M⁺ is a protonated nitrogen base or tetra-alkyl ammonium. Examples of M⁺ include: tetraalkyl ammonium, such as tetraethyl ammonium, tetrapropyl ammonium, tetrabutyl ammonium, and mixed tetralkyl ammonium species, e.g., dibutyl dimethyl ammonium; and protonated nitrogen bases, such as trialkyl ammonium, dialkyl ammonium, and alkyl ammonium.

In some embodiments, M⁺ is a protonated amine selected from the group consisting of (HNEt₃)⁺, (HNPr₃)⁺, and (HNBu₃)⁺.

Most hypophosphorous salts are quite soluble in solvents with solubility parameters above 10. Hypophosphorous salts in which the nitrogen base is tetrapropyl ammonium, tetrabutyl ammonium, dibutyl dimethyl ammonium, or (HNBu₃)⁺ tend to have lower solubility parameters than nitrogen bases with shorter or fewer alkyl groups, and can be used when the first solvent has a solubility parameter less than 10.

Polymers suitable for the processes of the present invention can be produced by free radical polymerization of a monomer mixture in the presence of one or more free radical initiators and one or more sulfur-based chain transfer agents (“RAFT agents”). Polymers that possess groups —SC(S)X made by other processes can also be employed in the processes of this invention. The polymer can be a homopolymer; a random, alternating or gradient copolymer; or a block, star, graft, branched, hyperbranched or dendritic polymer.

The polymer typically comprises repeat units derived from monomers selected from the group consisting of: methacrylates and acrylates such as methyl(meth)acrylate, ethyl(meth)acrylate, propyl(meth)acrylate (all isomers), butyl(meth)acrylate (all isomers), 2-ethylhexyl(meth)acrylate, isobornyl(meth)acrylate, (meth)acrylic acid, benzyl(meth)acrylate, phenyl(meth)acrylate, glycidyl(meth)acrylate, 2-hydroxyethyl(meth)acrylate, hydroxypropyl(meth)acrylate (all isomers), hydroxybutyl(meth)acrylate (all isomers), methyl alpha-hydroxy(meth)acrylate, ethyl alpha-hydroxy(meth)acrylate, butyl alpha-hydroxy(meth)acrylate, N,N-dimethylaminoethyl(meth)acrylate, N,N-diethylaminoethyl(meth)acrylate, triethyleneglycol(meth)acrylate, trimethoxysilylpropyl(meth)acrylate, triethoxysilylpropyl(meth)acrylate, tributoxysilyl propyl(meth)acrylate, dimethoxymethylsilylpropyl(meth)acrylate, diethoxymethylsilylpropyl(meth)acrylate, dibutoxymethylsilylpropyl(meth)acrylate, diisopropoxymethylsilylpropyl(meth)acrylate, dimethoxysilylpropyl(meth)acrylate, diethoxysilylpropyl(meth)acrylate, dibutoxysilylpropyl(meth)acrylate, and diisopropoxysilylpropyl(meth)acrylate; (meth)acrylonitrile;

styrenes such as styrene, acetoxystyrene, and substituted styrenes, wherein the substituent is selected from the group cosisting of alkyls, halogens, and halogen-substituted-alkyls;
itaconic anhydride and itaconic acid;
acrylamides and methacrylamides such as (meth)acrylamide, N-methylacrylamide, N,N-dimethylacrylamide, N-tert-butyl(meth)acrylamide, N-n-butyl(meth)acrylamide, N-methylol(meth)acrylamide, and N-ethylol(meth)acrylamide; vinyl benzoic acid (all isomers) and alpha-methylvinyl benzoic acid (all isomers);
p-vinylbenzene sulfonic acid and p-vinylbenzene sulfonate sodium salt; vinyl acetate, vinyl butyrate, vinyl benzoate, vinyl chloride, vinyl fluoride, and vinyl bromide; and
maleic anhydride, N-phenylmaleimide, N-butylmaleimide,
N-vinylpyrrolidone, N-vinylcarbazole, butadiene, isoprene, chloroprene, ethylene and propylene.

In some embodiments, the polymer is a polystyrene comprising repeat units selected from the group consisting of styrenes. In some embodiments, the polymer is a polymethacrylate comprising repeat units selected from the group of methacrylates. In some embodiments, the polymer is a polyacrylate comprising repeat units selected from the group of acrylates. In some embodiments, the polymer comprises repeat units selected from one or more of the groups of styrenes, acrylates and methacrylates.

The polymers used in the processes of this invention comprise one or more functional groups of the form:

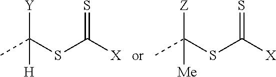

wherein
X is R, OR¹, N(R²)₂, SR³, or P(O)(OR⁴)₂;
Y is —CN, aryl, carboxyl, or C(O)NHR⁵;
Z is —CN, carboxyl, or C(O)NHR⁵;
R is substituted or unsubstituted C₁-C₂₅ alkyl; substituted or unsubstituted C₂-C₂₅ alkenyl; substituted or unsubstituted C₂-C₂₅ alkynyl; substituted or unsubstituted phenyl; substituted or unsubstituted naphthyl; and substituted or unsubstituted benzyl;
R¹, R², R³, and R⁴ are substituted or unsubstituted C₁-C₂₅ alkyl; substituted or unsubstituted C₆-C₁₀ aryl; a 3- to 8-membered carbocyclic or heterocyclic ring, or
N(R²)₂ is a 3- to 8-membered heterocyclic ring; and
R⁵ is C₁-C₆ alkyl or substituted alkyl.

Suitable radical initiators for use in the present invention include: peroxides, such as diisononanoyl peroxide, didecanoyl peroxide, di(3-carboxypropionyl) peroxide, didodecanoyl peroxide, 2,5-dimethyl-2,5-di(2-ethylhexanoylperoxy)hexane, dicumyl peroxide, dibenzoyl peroxide, and dilauroyl peroxide; peroxyesters, such as 3-hydroxy-1,1-dimethylbutyl peroxyneodecanoate, a-cumylperoxyneodecanoate, 2-hydroxy-1,1-dimethylbutyl peroxyneoheptanoate, a-cumyl peroxyneoheptanoate, t-amyl peroxyneodecanoate, t-butyl peroxyneodecanoate, 3-hydroxy-1,1-dimethylbutylperoxy-2-ethylhexanoate, t-butyl peroxyacetate, t-butyl peroxybenzoate, t-butyl peroxyoctoate, t-butyl peroxyneodecanoate, t-butylperoxy isobutyrate, t-amyl peroxypivalate, t-butyl peroxypivalate, t-amylperoxy 2-ethylhexanoate, t-butylperoxy 2-ethylhexanoate, di(2-ethylhexyl) peroxydicarbonate, di(n-propyl) peroxydicarbonate, di(sec-butyl)peroxydicarbonate, di-isopropyl peroxydicarbonate, and dicyclohexyl peroxydicarbonate; azo compounds, such as 2,2′-azobis(isobutyronitrile), 2,2′-azobis(2-cyano-2-butane), dimethyl 2,2′-azobis(methyl isobutyrate), 4,4′-azobis(4-cyanopentanoic acid), 4,4′-azobis(4-cyanopentan-1-ol), 1,1′-azobis(cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis[2-methyl-N-hydroxyethyl)]-propionamide, 2,2′-azobis(N,N′-dimethyleneisobutyramidine dihydrochloride, 2,2′-azobis(2-amidinopropane)dihydrochloride, 2,2′-azobis(N,N′-dimethyleneisobutyramine), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide, 2,2′-azobis[2-methyl-N-(2-hydroxyethyl) propionamide], 2,2′-azobis(isobutyramide)dihydrate, 2,2′-azobis(2,2,4-trimethylpentane), and 2,2′-azobis(2-methylpropane); peroxydisulfates, such as potassium peroxydisulfate and ammonium peroxydisulfate; and hyponitrites, such as di-t-butyl hyponitrite and dicumyl hyponitrite.

In some embodiments, the initiator is selected from the group consisting of dicumyl peroxide, dibenzoyl peroxide, dilauroyl peroxide, t-butyl peroxyoctoate, and t-butyl peroxyneodecanoate.

In the processes of this invention, a homogeneous solution is prepared comprising a first solvent, a salt of a hypophosphorous acid, M⁺H₂PO₂, and 25-80 wt % of a polymer comprising a functional group, —CHY—SC(S)X or —C(Me)Z—SC(S)X, wherein the wt % polymer is based on the combined weight of the polymer and the first solvent. In the homogeneous solution, both the salt of the hypophosphorous acid and the polymer are essentially completely dissolved, i.e., less than 2 wt % of either component remains in a separate phase. The homogeneous solution also comprises a low concentration of radicals derived from a radical initiator. There are several methods to establish a suitable concentration of radicals, and representative methods are described below.

Typically, the preparation of the homogeneous solution is conducted in an inert atmosphere (e.g., under N₂, argon, or other suitable gas that is inert under the reaction conditions).

In some embodiments, the polymer is dissolved in the first solvent before the addition of the hypophosphorous acid salt and before the addition of a radical initiator. Typically, the polymer is heated in the first solvent to facilitate dissolution. Suitable heating temperatures include about 50° C., 55° C., 60° C., 65° C., 70° C., 75° C., 80° C., 85° C., 90° C., 95° C., 100° C., 105° C., 110° C., 115° C., 120° C., 125° C., 130° C., or any range between two such temperatures, e.g., 50-80° C., 50-115° C., 90-115° C., or 80-120° C.

In some embodiments, the salt of the hypophosphorous acid, which can serve as a hydrogen atom donor, is added to a solution of the polymer in the first solvent. In some embodiments, the temperature of the solution at the time of the addition is 40-80° C., or 40-70° C., or 40-60° C., or 40-50° C.

In some embodiments, the polymer comprises 25-80 wt %, 30-80 wt %, 50-80 wt %, 60-75 wt %, or 70-80 wt % of the homogeneous solution, wherein the wt % polymer is based on the combined weight of the polymer and the first solvent.

The salt of the hypophosphorous acid is typically added as a 3-15 fold molar excess, based on the estimated moles of sulfur-containing functional groups, —CHY—SC(S)X or —C(Me)Z—SC(S)X. In some embodiments, the molar excess is 5-12 fold or 7-10 fold.

Stirring or other forms of mixing (agitation) facilitate the formation of a homogeneous solution.

In addition to the polymer, the first solvent and the salt of a hypophosphorous acid, the homogeneous solution also comprises a low concentration of radicals derived from a radical initiator. The radical initiator is typically dissolved in or mixed with a second solvent before being added to the homogeneous solution. Typically, the second solvent used is the same as the first solvent, i.e., the solvent used to dissolve the polymer.

The molar ratio of radical initiator to sulfur-containing functional groups is typically less that 1:1, for example, 1:1-30 (that is, 1:1 or 1:30, or any value in between), or 1:2-20, or 1:5-15.

The amount of second solvent used to form the radical initiator solution is not critical, but 2-20 wt % solutions are typical.

In some embodiments, the solution of the radical initiator is added to a solution of the polymer and hypophorphorous salt continuously or in small portions, typically over a period of several hours, so as to maintain a low, but nearly constant, radical flux in the solution. The optimal time period for addition depends primarily on the temperature of the solution and the half-life of the radical initiator at that temperature.

Typically, the rate of addition is such that the time period for the addition of the radical initiator solution is at least 3 half-lives of the radical initiator at the reaction temperature. For example, Luperox® 26 has a half-life of 1 hour at 94.6° C., so a solution of this radical initiator is added to the homogeneous solution of polymer and hypophosphorous acid salt over a period of at least 5 hours. In some embodiments, the time period of addition of the radical initiator is 3-30, or 5-20, or 10-15 half-lives of the initiator at the reaction temperature.

Computer programs (e.g., MATLAB™) are also available that can predict the radical concentration and help guide the choice of the rate of radical initiator addition. Such computer programs can also be used to estimate the concentration of radicals in the homogeneous solution.

In some embodiments, the radical initiator is added to a solution of the polymer and the hypophosphorous acid salt discontinuously, e.g., in one portion or in many portions. In this embodiment, the radical initiator typically has a long half-life at the reaction temperature, e.g., more than 20 or 10 or 5 or 2 hours at the reaction temperature of the solution.

In some embodiments, the solution of the polymer and hypophosphorous salt is heated before the addition of the radical initiator. In some embodiments, the addition of the radical initiator commences before the desired reaction temperature has been reached.

Suitable heating temperatures include about 50° C., 55° C., 60° C., 65° C., 70° C., 75° C., 80° C., 85° C., 90° C., 95° C., 100° C., 105° C., 110° C., 115° C., 120° C., 125° C., 130° C., or any range between two such temperatures, e.g., 50-80° C., 50-115° C., 90-115° C., or 80-120° C.

The progress of the reaction can be monitored, for example, by uv-vis spectra, e.g., the absorbance at 312 nm. In the case of the examples below, the solution typically turns colorless and the absorbance peak at 312 nm disappears as the trithiocarbonate end groups are removed.

In some embodiments, the solution is heated for at least 0.2 or 1 or 2 or 5 or 10 hours, depending on the half-life of the radical initiator and the reaction rate at the reaction temperature of the solution.

To minimize degradation of the polymer after end-group removal, it may be desirable to monitor the progress of the reaction and reduce the temperature when the desired reduction in sulfur-containing end groups has been achieved. Essentially complete (e.g., >99.9%) removal is readily achieved.

The polymer product produced by a process of this invention can be isolated by standard polymer isolation techniques, e.g., precipitation, chromatography, or extraction.

The polymers produced by the processes described herein are useful in many applications in which polymers of low polydispersity and compositional or architectural control are desired, e.g., photoresists, dispersants, and medical applications. The absence of high molecular weight, coupled products allows these polymers to be used in applications in which molecular weight uniformity is critical.

### EXAMPLES

The following examples illustrate certain features and advantages of the present invention. They are intended to be illustrative of the invention, but not limiting. All percentages are by weight, unless otherwise indicated.

### Definition of Chemicals and Monomers Used (Commercial Source)

Luperox® 26 is tert-butylperoxy-2-ethylhexanoate, available from Arkema, Inc. (King of Prussia, Pa.).

Vazo® 88 is 1,1′-azobis(cyanocyclohexane), available from E. I. du Pont de Nemours and Company, Wilmington, Del.

V-601 is dimethyl 2,2′-azobis(2-methylpropionate), available from Wako Chemicals USA, Inc., Richmond, Va.

“MEK” is methyl ethyl ketone.

“MPK” is methyl propyl ketone.

“DMAC” is N,N-dimethylacetamide.

“Polystyrene-ttc” is polystyrene with end groups derived from a trithiocarbonate RAFT agent.

“PMMA-ttc” is polymethylmethacrylate with end groups derived from a trithiocarbonate RAFT agent.

“Polystyrene-H” is polystyrene terminated by a hydrogen atom.

“PMMA-H” is polymethylmethacrylate terminated by a hydrogen atom.

### Preparation of Triethylammonium Hypophosphite

A mixture of hypophosphorous acid (6.6 g of a 50% aqueous solution) and toluene (30 mL) was cooled in ice and treated dropwise with triethylamine (5.0 g). Water was removed by azeotropic distillation under vacuum, and then residual toluene was evaporated to provide a nearly colorless, viscous oil.

### Preparation of S-Cyanomethyl S-dodecyl trithiocarbonate RAFT Agent

A 1000 mL 3-neck round bottom flask (fitted with mechanical stirrer, septum, thermocouple well, and reflux condenser with N₂ bubbler) was charged with sodium hydroxide (12.18 g, 304.5 mmol) and water (30 mL). Isopropanol (500 mL) was added to the solution of sodium hydroxide, and the solution was cooled to about 5° C. The cooled solution was treated dropwise with dodecanethiol (60.6 g, 300 mmol).

The solution was stirred for 30 min at 5° C., cooled to 0° C., and treated with carbon disulfide (24.0 g, 315 mmol) by syringe over ca. 10 min to produce a yellow solution which was stirred at ca. 0-5° C. for 0.5 h.

The solution was treated with chloroacetonitrile (23.8 g, 315 mmol) dropwise by syringe over ca. 20 min while maintaining the temperature between 0° C. and 5° C. The solution was stirred at 0° C. for 2 h.

The solution was warmed to ca. 30° C. and filtered to remove sodium chloride. The solid residue was washed with isopropanol (5 mL). The combined filtrate was treated with water (50 mL). Product crystals of S-cyanomethyl S-dodecyl trithiocarbonate were formed as the temperature decreased. After the bulk of crystals had formed at room temperature, the mixture was cooled to 0° C. for 1.5 h and the first crop of crystals was collected. There was obtained 82.3 g of bright yellow flakes after drying. The filtrate was treated with another 50 mL water and chilled to provide 8.5 g of the product in the second crop of crystals. ¹H NMR analyses showed both crops of ca. 98% purity (93% isolated yield).

### Preparation of Trithiocarbonate RAFT Agent, C₁₂H₂₅SC(S)SC(CH₃)(CN)CH₂CH₂CO₂CH₃

### Step 1: Preparation of Bis(dodecylsulfanylthiocarbonyl)Disulfide

A 2000 mL, 4-neck round bottom flask (fitted with mechanical stirrer, septum, thermocouple well, and reflux condenser with N₂ bubbler) was charged with heptane (1000 mL) and a solution of potassium t-butoxide in tetrahydrofuran (174.4 g, containing 34.7 g potassium t-butoxide, 0.31 mol). The resulting solution was cooled to ca. 5° C. and reacted with dodecanethiol (60.6 g, 0.30 mol, Sigma-Aldrich Co., Milwaukee, Wis.). The resulting white slurry was stirred for 30 min at 5-10° C. and then reacted with carbon disulfide (23.5 g, 0.31 mol) over 20 min. The mixture was stirred at 5° C. for 10 min, allowed to warm to 20-23° C. and stirred for 4 h. The resulting yellow slurry was reacted in portions with iodine (40.0 g, 0.158 mol) over 40 min at 16-18° C. The mixture was stirred at room temperature for 15 h. Distilled water was added, and the separated organic phase was washed with a solution of sodium chloride and sodium thiosulfate, then with a sodium chloride solution. The organic layer was dried and the solvent was evaporated to provide 84.2 g (98%) of yellow solid.

### Step 2: Preparation of 4-Cyano-4-(dodecylsulfanythiocarbonyl)sulfanyl Pentanoic Acid

A 2 L, 3-neck flask fitted with reflux condenser, solids addition port, thermowell, and stir bar was charged with bis(dodecylsulfanylthiocarbonyl)disulfide (84.1 g, 151.6 mmol) and 760 mL ethyl acetate. The resulting solution was heated to gentle reflux and reacted with 4,4′-azobis(4-cyanopentanoic acid) (72.1 g, 257 mmol) (Wako Chemicals USA, Inc., Richmond, Va.) over 3.75 h. The solution was heated for an additional 16 h.

Ethyl acetate was removed under reduced pressure and the product was allowed to crystallize from heptane. The solid was filtered, washed with water, and dried to provide 110.0 g (91%).

### Step 3: Preparation of Methyl 4-Cyano-4-(dodecylsulfanythiocarbonyl)sulfanyl Pentanoate

A solution of 4-cyano-4-(dodecylsulfanythiocarbonyl)sulfanyl pentanoic acid (C₁₂H₂₅SC(S)SC(Me)(CN)CH₂CH₂CO₂H, 64.8 g, 160.5 mmol) in THF (195 mL) at 5-10° C. was treated with diazabicyclo[5.4.0]undec-7-ene (26.9 g, 176.6 mmol). The mixture was stirred for 5 min, then treated with methyl iodide (25.9 g, 182 mmol), and the resulting mixture was stirred for 18 h.

The solution was diluted with heptane, filtered, and the solid was rinsed with heptane. The filtrate was washed successively with dilute sodium chloride, 1N hydrochloric acid, dilute sodium bicarbonate solution, and water. The dried organic phase was evaporated to give 64.13 g (96%) of amber oil.

### Characterization Methods

Size exclusion chromatography with the triple detection method was carried out using an SEC system Model Alliance 2690™ from Waters Corporation (Milford, Mass.), with a Waters 410™ refractive index detector (DR1) and Viscotek Corporation (Houston, Tex.) Model T-60A™ dual detector module incorporating static right angle light scattering and differential capillary viscometer detectors. Data reduction, incorporating data from all three detectors (refractometer, viscometer and light scattering photometer (right angle)), was performed with Trisec® GPC version 3.0 by Viscotek. The Flory-Fox equation was used for angular asymmetry light scattering correction. All chromatographic columns were obtained from Polymer Laboratories (Church Stretton, UK): two PL Gel Mixed C linear columns and one PL Gel 500A column to improve resolution at the low molecular weight region of a polymer distribution. The mobile phase was THF, stabilized with 0.05% BHT from J. T. Baker, Phillipsburg, N.J.

### Example 1

### 3400 Mw Polystyrene-ttc Via RAFT Polymerization

A 4-necked, 500 mL round bottom flask equipped with 2 addition funnels, a thermocouple, a reflux condenser and an N₂ adapter was charged with trithiocarbonate RAFT agent NCCH₂SC(S)SC₁₂H₂₅ (5.50 g, 17.3 mmol) and MEK (30 mL). One addition funnel was charged with a solution of Luperox® 26 (0.53 g, 2.68 mmol) in MEK (25 mL). The other addition funnel was charged with inhibitor-free styrene (84.2 g, 0.808 mol). The reaction vessel was purged with N₂ for 15 min, then 10 g of styrene were added, and the contents were heated to 90° C. over ca. 15 min. Initiator and monomer feeds were started, and styrene was fed over 1 hr, while initiator was fed over 5 hr. Heating was continued at a bath temperature of 95° C. for 22 hr.

Styrene conversion was determined to be 77% (NMR). Product was isolated by inverse precipitation with methanol (1 L). Filtration and drying gave 69.4 g of a yellow solid.

SEC (vs. PS standards): Mw=3433; Mn=3194; MP=3519;

### M_{z}=3666; PD=1.075.

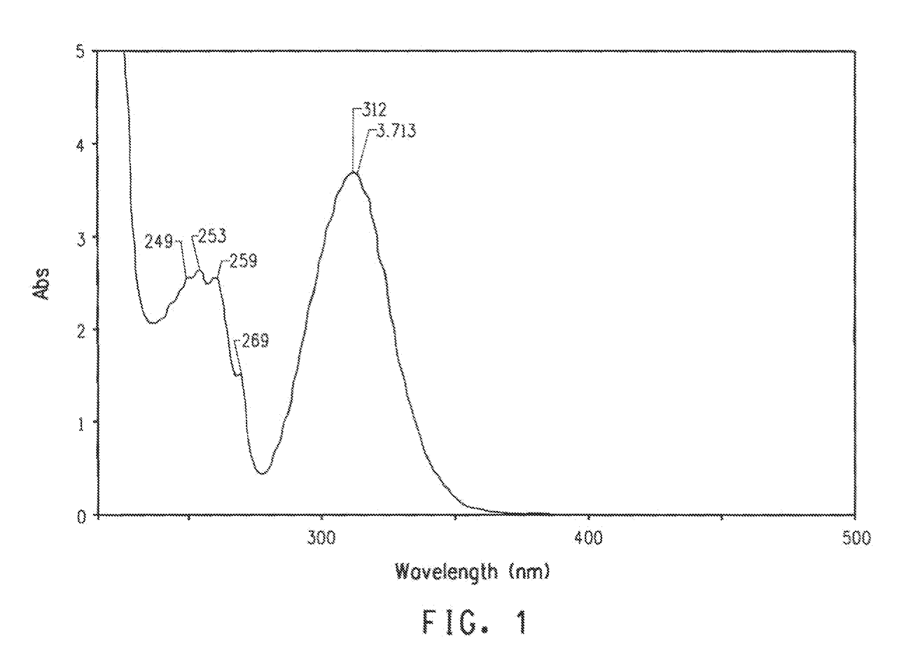

UV (1.00 g/L, THF, 1 cm): A₃₁₂=3.713. FIG. 1 shows the large absorbance peak at A₃₁₂, due to the presence of trithiocarbonate.

NMR (CDCl₃) showed: —C(C₆H₅)H—SC(S) at 5.02-4.60 (m, a=4.257), 3.30-3.18 (m, a=8.286, SCH₂), 0.88 (t, a=13.0, CH₃ terminal of C₁₂ fragment).

### Radical Reduction of 3400 Mw Polystyrene-ttc

A 3-necked round bottom flask was fitted with an overhead stirring assembly, internal thermocouple, reflux condenser, syringe pump feed system, and N₂ inlet. The reaction vessel was charged with 3400 Mw polystyrene-ttc prepared as described above (60.0 g; estimated as 15.0 mmol trithiocarbonate) which was dissolved in DMAC (68.0 g) at ca. 75° C. The 46.9 wt % solids solution was cooled to ca. 50° C., and triethylammonium hypophosphite (10.0 g, 60.0 mmol) was added and mixed well. The syringe was charged with a solution of Luperox® 26 (0.679 g, 3.14 mmol) in DMAC (3.00 g). The solution was purged with N₂ for 20 min, heated in an oil bath maintained at 105° C., and treated with the solution of Luperox® 26 over a 10 hr period (0.40 mL/hr). An additional Luperox 26 charge (0.340 g, 1.57 mmol, in 1.50 g DMAC) was added over a 5 hr period. Heating was continued for 1 hr. A colorless solution was produced as the last portion of initiator solution was added. Heating was continued for another 1 hr.

The solution was diluted with MEK (100 mL). The homogeneous solution was cooled, transferred to a 2 L vessel and treated slowly with methanol (1 L) to precipitate the product. The liquid phase was removed with a fritted dip tube, and the product was re-precipitated using MEK/MeOH. Product was re-dissolved in THF (100 mL) and precipitated by adding methanol (1 L). After filtration and drying, the white solid was vacuum oven-dried (60° C., N₂ make-up) to provide 53.5 g of white solid. Residual THF was estimated as 600 ppm (NMR).

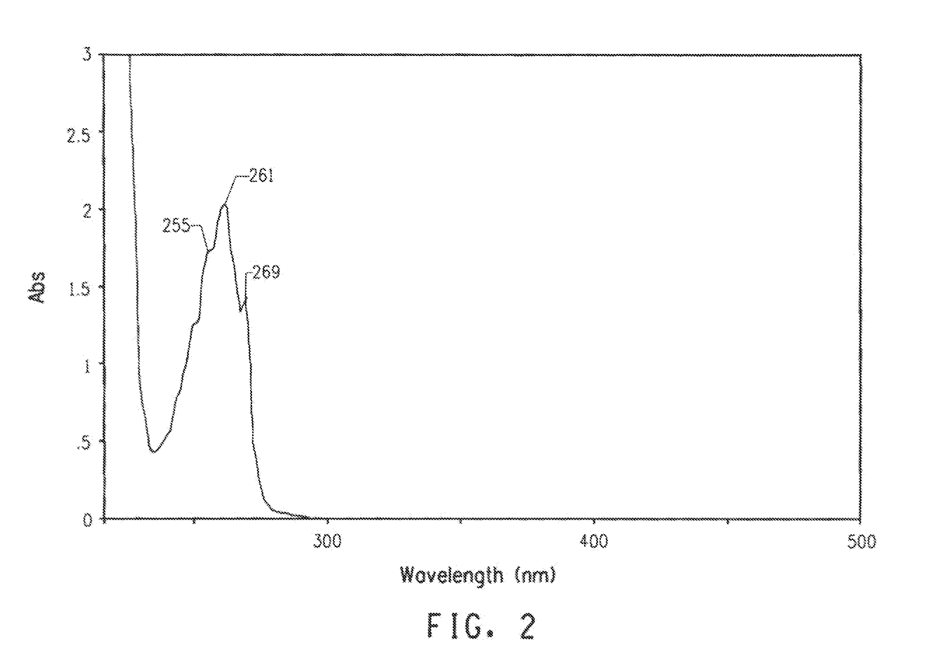

UV (THF, 1.00 g/L, 1 cm): A₃₁₂=0.00. Conversion of trithiocarbonate>99.9%, as evidenced by reduction of absorbance above 300 nm, as shown in FIG. 2.

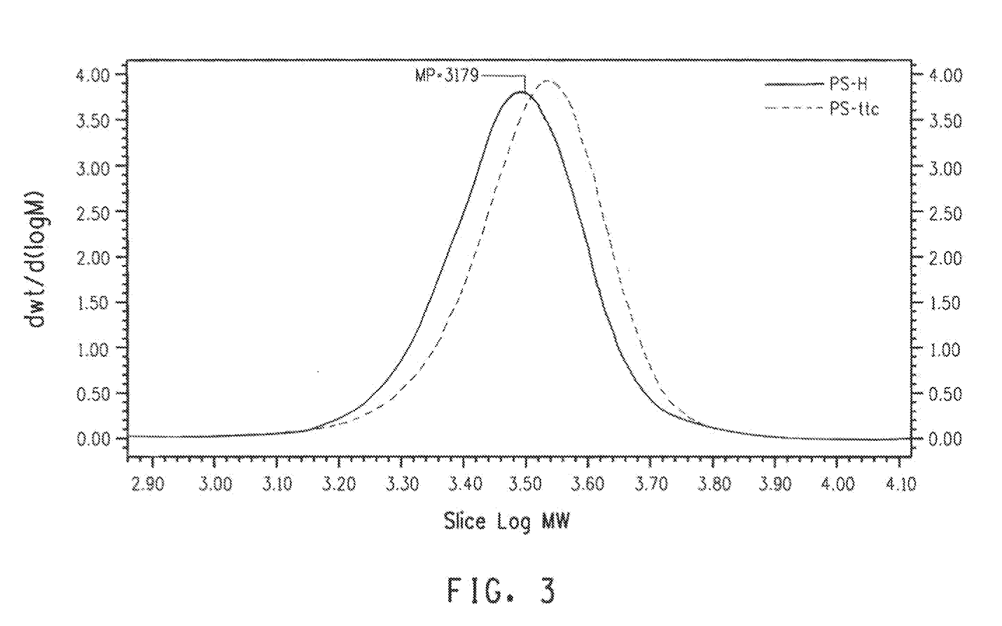

SEC (vs. PS standards): Mw=3181, Mn=2957, Mz=3424, MP=3164, PD=1.076. Reduction in molecular weight vs. starting polystyrene-ttc is consistent with end-group fragment loss (C₁₂H₂₅SC(S)S-=277), as indicated in FIG. 3 by the shift of molecular weight distribution curve to the left.

### Example 2

### 7500 Mw Polystyrene-ttc Via RAFT Polymerization

A 4-necked, 500 mL round bottom flask equipped with 2 addition funnels, a thermocouple, a reflux condenser and an N₂ adapter was charged with trithiocarbonate RAFT agent NCCH₂SC(S)SC₁₂H₂₅ (2.75 g, 8.67 mmol) and MEK (30 mL). One addition funnel was charged with a solution of Luperox® 26 (0.265 g, 1.34 mmol) in MEK (25 mL). The other addition funnel was charged with inhibitor-free styrene (84.2 g, 0.808 mol). The reaction vessel was purged with N₂ for 15 min, then 10 g of styrene were added and the contents were heated to 90° C. over ca. 15 min. Initiator and monomer feeds were started, and styrene was fed over 1 hr, while initiator was fed over 5 hr. An additional 0.070 g of Luperox® 26 was added after 5 hr. Heating was continued at a bath temperature of 95° C. for 46 hr.

Styrene conversion was determined to be 80% (NMR). Product was isolated by inverse precipitation with methanol (1 L). Filtration and drying gave 67.9 g of a yellow solid.

SEC (vs. PS standards): Mw=7461, Mn=6685, MP=7880, Mz=8135, PD=1.12.

UV (1.00 g/L, THF, 1 cm): A₃₁₂=1.985.

### Radical Reduction of 7500 Mw Polystyrene-ttc in DMAC, Adding LuDerox® 26 Over 10 Hours

A 3-necked round bottom flask was fitted with an overhead stirring assembly, internal thermocouple, reflux condenser; syringe pump feed system, and N₂ inlet. The flask was charged with a sample of 7500 Mw polystyrene-ttc prepared as described above (60.0 g; estimated as 7.2 mmol trithiocarbonate) which was dissolved in DMAC (66.0 g) at ca. 75° C. The 47.6 wt % solids solution was cooled to ca. 40-50° C., then triethylammonium hypophosphite (9.62 g, 57.6 mmol) was added and mixed well. The syringe pump was charged with a solution of Luperox® 26 (0.327 g, 1.513 mmol) in DMAC (3.76 g). The solution was purged with nitrogen for 20 min, heated in an oil bath maintained at 105° C., and treated with the solution of Luperox® 26 over a 10 hr period (0.40 mL/hr). The solution was heated for an additional 0.75 hr at 105° C. The solution had become colorless.

The solution was diluted with MEK (125 mL), and the mixture was warmed to ca. 75° C. to aid stirring. The homogeneous solution was cooled, and treated slowly with methanol (2 L) to precipitate the product. Liquid phase was removed with a fritted dip tube, and product was re-precipitated using MEK/MeOH. Product was dissolved in THF (100 mL) and precipitated by adding methanol (2 L). Filtration and drying provided 59.1 g of a white solid.

SEC (vs. PS standards): Mw=7159, Mn=6485, Mz=7797, MP=7465, PD=1.104.

UV (THF, 1.00 g/L, 1 cm): A₃₁₂=0.00, consistent with >99.9% conversion of trithiocarbonate.

### Comparative Example A

### Radical Reduction of 7500 Mw Polystyrene-ttc in which Luperox® 26 was Added in Two Portions

A 3-necked round bottom flask was fitted with a stir bar, internal thermocouple, and N₂ inlet. A sample of 7500 Mw polystyrene-ttc prepared as described above (2.0 g; estimated as 0.240 mmol trithiocarbonate) was dissolved in DMAC (2.50 g) at ca. 75° C. The 44.4 wt % solids solution was cooled to ca. 40-50° C., and triethylammonium hypophosphite and Luperox® 26 (10.9 mg, 0.050 mmol) were added and mixed well. The solution was purged with N₂ for 20 min and heated in an oil bath maintained at 105° C. After heating for 5 hr, the mixture was cooled to ca. 40° C., treated with another portion of Luperox® 26 (10.9 mg) in DMAC (0.15 g), and heated at 105° C. for another 6 hr period.

The colorless solution was diluted with MEK (4 mL). The homogeneous solution was cooled, transferred to a 100 mL vessel and treated slowly with methanol (65 mL) to precipitate the product. The liquid phase was removed with a fritted dip tube, and product was re-precipitated using MEK/methanol. Product was re-dissolved in THF and precipitated by adding methanol (65 mL). After filtration and drying, a white solid (1.7 g) was obtained.

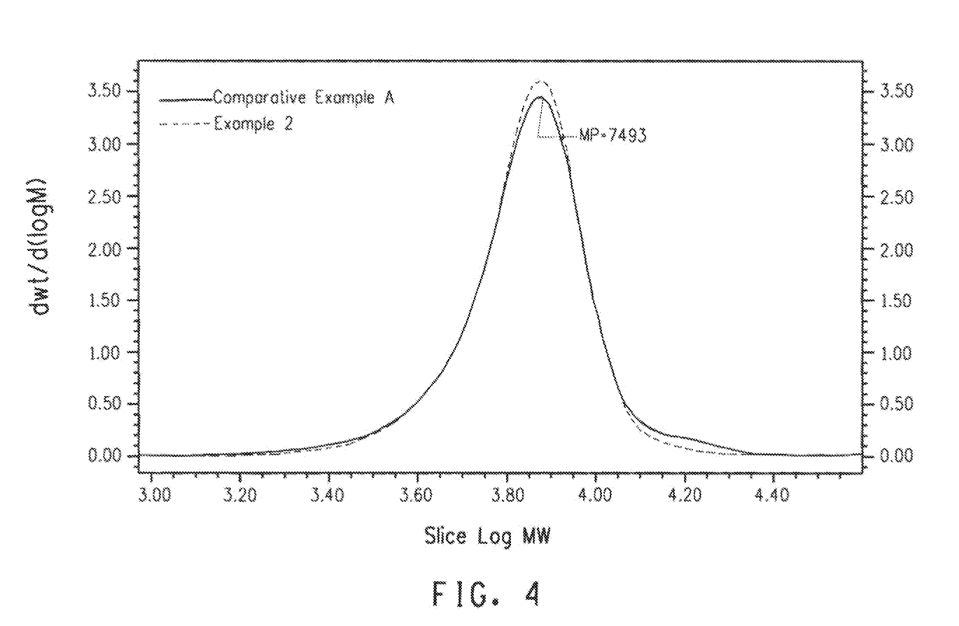

SEC (vs. PS standards): Mw=7293, Mn=6469, Mz=8154, MP=7493 PD=1.127. The SEC trace (FIG. 4) shows a small amount of coupling product (log MW ca. 4.20). Mz and PD are also higher than when the initiator (Luperox® 26) was added over a 10 hr period.

UV (THF, 1.00 g/L, 1 cm): A₃₁₂=0.00. Conversion of trithiocarbonate>99.9%.

### Example 3

### 22000 Mw Polystyrene-ttc Via RAFT Polymerization

A 4-necked, 500 mL round bottom flask equipped with an addition funnel, thermocouple, reflux condenser and N₂ adapter was charged with trithiocarbonate RAFT agent NCCH₂SC(S)SC₁₂H₂₅ (1.43 g, 4.5 mmol), methyl propyl ketone (MPK, 16 mL), and inhibitor-free styrene (100.0 g, 0.96 mol). The addition funnel was charged with a solution of Vazo® 88 (0.367 g, 1.5 mmol) in MPK (16 mL). The reaction vessel was purged with N₂ for 20 min, and then the contents were heated to 110° C. over ca. 20 min. Half of the initiator solution was added to begin the reaction; the remaining initiator solution was added in equal parts after 4 hr and 6 hr. Heating was continued at 110° C. for 18 hr.

Styrene conversion was determined to be 94% (NMR). The mixture was diluted with THF (175 mL) and added to stirred methanol (1.6 L) to precipitate the product. Filtration and drying gave 94.9 g of a yellow solid.

SEC (vs. polystyrene standards): Mw=21940, Mn=18040, MP=23210, Mz=24940, PD=1.22.

UV (1.00 g/L, THF, 1 cm): A₃₁₂=0.729.

### Radical Reduction of 22000 Mw Polystyrene-ttc in DMAC, Adding Luperox® 26 Over 10 Hours

A sample of 22000 Mw polystyrene-ttc prepared as described above (11.25 g; estimated as 0.533 mmol trithiocarbonate) was dissolved in DMAC (9.2 g) at ca. 75° C. in a 3-necked round bottom flask fitted with a stir bar, internal thermocouple, reflux condenser, syringe pump feed system, and N₂ inlet. The resulting 55 wt % solids solution was cooled to ca. 40-50° C. and triethylammonium hypophosphite (0.713 g, 4.27 mmol) was added and mixed well. The syringe pump was charged with a solution of Luperox® 26 (0.022 g, 0.102 mmol) in DMAC (0.94 g). The solution was purged with N₂ for 20 min, heated in an oil bath maintained at 105° C., and treated with the solution of Luperox® 26 over a 10 hr period (0.1 mL/hr). The solution was heated for an additional 0.75 hr at 105° C. The solution had become colorless.

The solution was diluted with MEK (25 mL), and the homogeneous solution was cooled, transferred to a 1 L vessel and treated slowly with methanol (400 mL) to precipitate the product. Filtration and drying provided 11.2 g of white powder. Product was precipitated 2 more times, using 30 mL MEK/400 mL methanol. Filtration and drying overnight on the funnel gave 10.55 g.

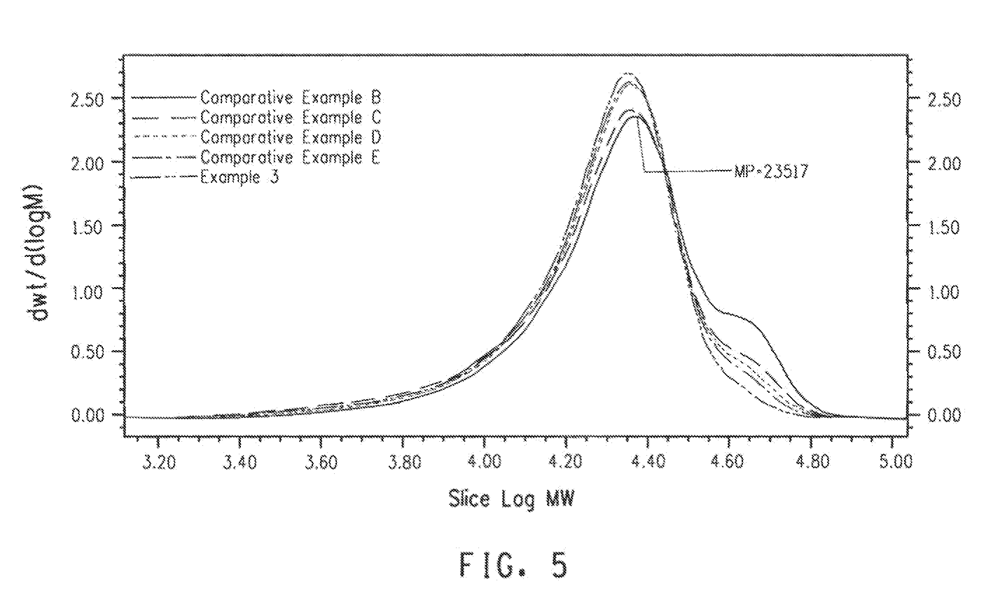

SEC (vs polystyrene standards): Mw=20,705, Mn=16247, Mz=24168, MP=23040, PD=1.274. FIG. 5 shows the superimposed SEC graphs for this example and the corresponding Comparative Examples B-E (described below).

UV (THF, 1.00 g/L, 1 cm): A₃₁₂=0.00, indicating conversion of trithiocarbonate>99.5%.

NMR (CDCl₃): small amount of MEK remained, ca. 1.4 wt %. No observable peaks for Et₃NH or H₂PO₃.

### Comparative Example B

### Radical Reduction of 22000 Mw Polystyrene-ttc in MPK at Low Solids, Adding Lauroyl Peroxide Over 2 Hours

A 3-necked round bottom flask was fitted with a stir bar, internal thermocouple, reflux condenser, dropping funnel and N₂ inlet. The reaction vessel was charged with a sample of 22000 Mw polystyrene-ttc (5.0 g; estimated as 0.237 mmol trithiocarbonate) which was dissolved in MPK (20 g, 20 wt % solids). Triethylammonium hypophosphite (0.396 g, 2.37 mmol) was added. The addition funnel was charged with a solution of lauroyl peroxide (LP, 0.076 g, 0.191 mmol) in 7.6 g MPK. The solution was purged with N₂ for 20 min, heated to 105° C., and treated with the solution of LP over a 2 hr period. The solution had become colorless.

The cooled polymer solution in a 500 mL Erlenmeyer flask was treated with methanol (300 mL) to precipitate the product. After stirring for 5 min, the product was filtered, washed with methanol and dried to provide a white solid. UV analysis indicated >99% conversion of trithiocarbonate.

SEC (vs. polystyrene standards): Mw=24142, Mn=18466, Mz=29493, MP=23517, PD=1.307. A significant amount of coupling is evident, as indicated by the peak shoulder in FIG. 5.

### Comparative Example C

### Radical Reduction of 22000 Mw Polystyrene-ttc in MPK, Adding Lauroyl Peroxide Over 6.3 Hours

A 3-necked round bottom flask was fitted with a stir bar, internal thermocouple, reflux condenser, dropping funnel and N₂ inlet. The reaction vessel was charged with a sample of 22000 Mw polystyrene-ttc (5.0 g; estimated as 0.237 mmol trithiocarbonate) which was dissolved in MPK (20 g, 20 wt % solids). Triethylammonium hypophosphite (0.396 g, 2.37 mmol) was added. The addition funnel was charged with a solution of lauroyl peroxide (LP, 31 mg, 0.078 mmol) in MPK (5.2 g). The solution was purged with N₂ for 20 min, heated to 105° C., and treated with the solution of LP over a 6.3 hr period. The mixture was heated at reflux for an additional hour. A trace of yellow color remained.

The cooled polymer solution was treated with methanol to precipitate the product. This was filtered, washed with methanol and dried to provide an off-white solid. Conversion of trithiocarbonate was 95%.

SEC: Mw=15801, Mn=21912, Mz=26963, MP=23249, PD=1.387. A small fraction of coupled product is evident from the SEC trace (FIG. 5).

UV (1.000 g/L, THF, 1 cm): A₃₀₆=0.034

### Comparative Example D

### Radical Reduction of 22000 Mw Polystyrene-ttc in MPK, Adding Luperox® 26 Over 8.5 Hours

A 3-necked round bottom flask was fitted with a stir bar, internal thermocouple, reflux condenser, dropping funnel and N₂ inlet. The reaction vessel was charged with a sample of 22000 Mw polystyrene-ttc (5.0 g; estimated as 0.237 mmol trithiocarbonate) which was dissolved in MPK (20 g, 20 wt % solids). Triethylammonium hypophosphite (0.396 g, 2.37 mmol) was added. The addition funnel was charged with a solution of Luperox® 26 (9.8 mg, 0.045 mmol) in MPK (4.6 g). The solution was purged with N₂ for 20 min, heated to 105° C., and treated with the Luperox® 26 solution over an 8.5 hr period. The mixture was heated at reflux for an additional 3 hr to provide a colorless solution.

The cooled polymer solution was treated with methanol to precipitate the product. The product was filtered, washed with methanol and dried to provide a white solid. Conversion of trithiocarbonate was >99.5%.

SEC (vs polystyrene standards): Mw=22043, Mn=17197, Mz=26208, MP=23312, PD=1.282. Coupling, although less than observed for Comparative Examples B and C, is still apparent in FIG. 5.

UV (1.000 g/L, THF, 1 cm): A₃₀₆=end absorption only.

### Comparative Example E

### Radical Reduction of 22000 Mw Polystyrene-ttc in MPK, Adding Luperox® 26 Over 10 Hours

A 3-necked round bottom flask was fitted with a stir bar, internal thermocouple, reflux condenser, dropping funnel and N₂ inlet. The reaction vessel was charged with a sample of 22000 Mw polystyrene-ttc (5.0 g; estimated as 0.237 mmol trithiocarbonate) which was dissolved in MPK (20 g, 20 wt % solids). Triethylammonium hypophosphite (0.396 g, 2.37 mmol) was added. The addition funnel was charged with a solution of Luperox® 26 (9.8 mg, 0.045 mmol) in MPK (4.6 g). The solution was purged with N₂ for 20 min, heated to 105° C., and treated with the Luperox® 26 solution over a 10 hr period. The mixture was heated at reflux for an additional 3 hr to provide a colorless solution.

The cooled polymer solution was treated with methanol to precipitate the product. This was filtered, washed with methanol and dried to provide a white solid. Conversion of trithiocarbonate was >99.5%.

SEC (vs polystyrene standards): Mw=21604, Mn=17094, Mz=25510, MP=231934, PD=1.264. Molecular weight distribution was very similar to that obtained in the 6.3 hr feed experiment (Comparative Example C).

UV (1.000 g/L, THF, 1 cm): A₃₀₆=end absorption only.

### Comparative Example F

### Radical Reduction of 22000 Mw Polystyrene-ttc in MPK, at High Solids and Addition of Luperox® 26 over 10 Hours

A 3-neck round bottom flask was fitted with a stir bar, internal thermocouple, reflux condenser, syringe pump feed system, and N₂ inlet.

The reaction vessel was charged with 22000 Mw polystyrene-ttc prepared as described above (11.25 g; estimated as 0.533 mmol of RAFT end group content), which was dissolved in methyl propylketone (MPK, 7.5 g; 60 wt % solids) at ca. 70° C. This polymer solution was cooled to ca. 50° C. and then triethylammonium hypophosphite (0.713 g, 4.27 mmol) was added, resulting in a heterogeneous, turbid mixture. The syringe was charged with a solution of Luperox® 26 (0.022 g, 0.102 mmol) in 0.8 g MPK). The polymer/hypophosphite solution was purged with N₂ for 20 min, heated to 102° C., and then treated with the solution of Luperox® 26 over a 10 hr period (0.1 mL/hr). An aliquot of the yellow solution was treated with methanol for polymer isolation and UV analysis. Absorbance at 312 nm was >95% of that measured for the 22000 Mw polystyrene-ttc material, indicating that less than 5% of the trithiocarbonate had been converted.

This Comparative Example demonstrates that poor solubility of the hypophosphite leads to low conversion of the trithiocarbonate end groups.

### Example 4

### Radical Reduction of 22000 Mw Polystyrene-ttc in DMAC, Adding t-Butyl Peroxybenzoate in One Portion

A sample of 22000 Mw polystyrene-ttc (5.00 g, estimated as 0.237 mmol trithiocarbonate) was dissolved in DMAC (4.44 g) in a 3-neck round bottom flask fitted with a stir bar, internal thermocouple, reflux condenser, and N₂ inlet. The polymer was dissolved at ca. 75° C. The 53 wt % solids solution was then cooled to ca. 40-50° C. and triethylammonium hypophosphite (0.316 g, 1.90 mmol) was added and mixed well. t-Butyl peroxybenzoate (Luperox® P, 9.3 mg, 0.0475 mmol) was added. The solution was purged with N₂ for 20 min, heated in an oil bath maintained at 105° C., and stirred for 21 hr. The resulting solution was colorless.

The solution was diluted with MEK (10 mL), and the homogeneous solution was cooled, transferred to a 500 mL vessel and treated slowly with methanol (200 mL) to precipitate the product. Product was precipitated 2 more times, using 20 mL MEK/400 mL methanol. Filtration and drying overnight on a funnel gave 4.81 g of product.

UV (THF, 1.00 g/L, 1 cm): A₃₁₂=0.008 Conversion was ca.99%.

SEC (vs polystyrene): Mw=20761, Mn=16545, Mz=24196, MP=22790, PDI=1.255.

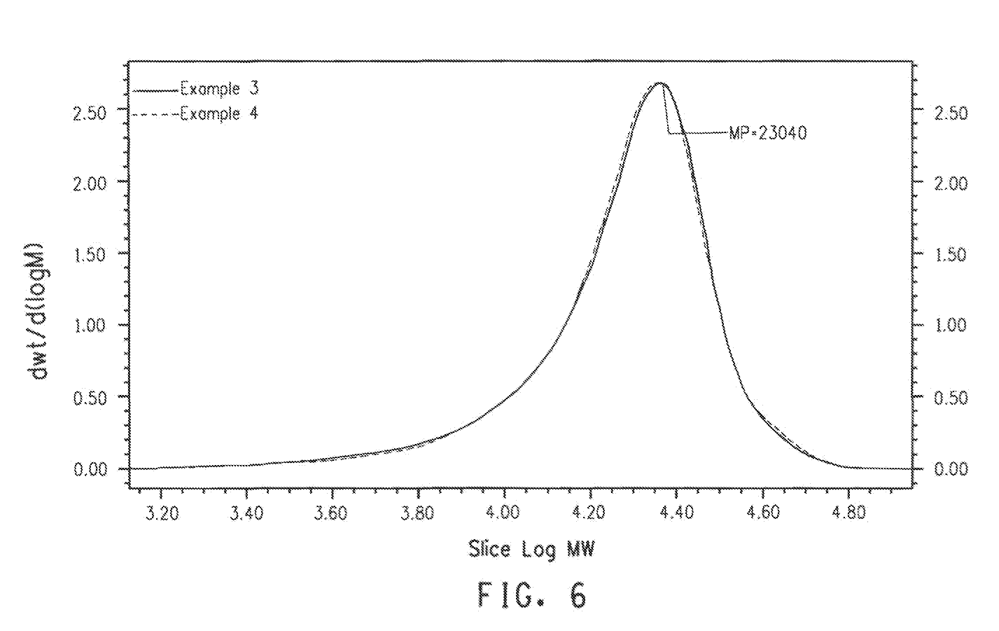

FIG. 6, an overlay of the SEC traces of the polymers of this example and that of Example 3 (in which Luperox® 26 was fed over 10 hr) shows nearly identical band shapes. This demonstrates that coupling can also be minimized by use of a radical initiator with a long half-life at the temperature of the reaction.

### Example 5

### Radical Reduction of 22000 Mw Polystyrene-ttc in DMAC, Adding t-Butyl Peroxybenzoate in One Portion

A sample of 22000 Mw polystyrene-ttc (4.00 g, estimated as 0.190 mmol trithiocarbonate) was dissolved in DMAC (9.2 g) in a 3-neck round bottom flask fitted with a stir bar, internal thermocouple, reflux condenser, and N₂ inlet. The polymer was dissolved at ca. 75° C. The 30 wt % solids solution was cooled to ca. 40-50° C. and triethylammonium hypophosphite (0.253 g, 1.52 mmol) was added and mixed well. t-Butyl peroxybenzoate (Luperox® P, 8.2 mg, 0.0422 mmol) was added. The solution was purged with N₂ for 20 min, heated in an oil bath maintained at 105° C., and stirred for 23 hr. The resulting solution was colorless.

The solution was diluted with MEK (5 mL), and the solution was cooled, transferred to a 500 mL vessel and treated slowly with methanol (200 mL) to precipitate the product. Product was precipitated 2 more times, using 20 mL MEK/400 mL methanol. Filtration and drying overnight on a funnel gave 3.75 g of product.

UV (THF, 1.00 g/L, 1 cm): A₃₁₂=0.00 Conversion was >99.5%.

SEC (vs polystyrene): Mw=20812, Mn=16415, Mz=24483, MP=22613, PDI=1.268.

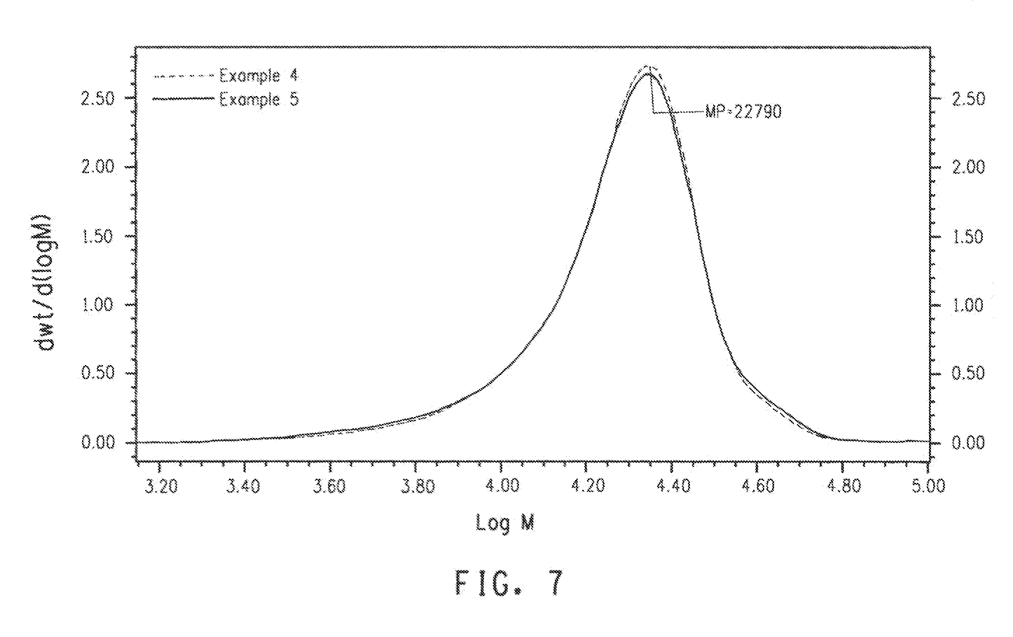

FIG. 7, an overlay of the SEC traces of the polymer of this example and that of Example 4 (in which % solids was 53%) shows nearly identical band shapes. This demonstrates that coupling can be substantially reduced by operating at a solids loading as low as 30 wt %.

### Example 6

### 14600 Mw PMMA-ttc Via RAFT Polymerization

A 3-necked flask fitted with an addition funnel, condenser, and N₂ inlet, a thermocouple, and an overhead stirrer assembly was charged with trithiocarbonate RAFT agent C₁₂H₂₅SC(S)SC(CH₃)(CN)CH₂CH₂CO₂CH₃ (3.59 g, 8.61 mmol) and MEK (35 mL). Initiator (V-601, FW=230.26, 200 mg, 0.87 mmol; [RAFT]/[initiator]=10) was added. The addition funnel was charged with methyl methacrylate (MMA, 100 g) in MEK (35 mL). A 10.0 ml portion of monomer feed was added, and the reaction vessel was purged with N₂ for 20 min. The temperature was increased to 75° C. The remaining monomer solution was fed over 1.5 hr. After 5 hr, another 50 mg of V-601 in 3 mL MEK was added by syringe through the addition funnel port. Heating was continued for an additional 19 hr to give a hard, amorphous material.

¹H NMR (CDCl₃) showed conversion was 99%. The solution was diluted with MEK (1 L) then added to methanol (3 L) to precipitate the product. A solid was collected and dried to give 95.8 g.

SEC (vs. PMMA standards): Mw=14625, Mn=13330, Mz=15770, MP=15479, PD=1.097.

### Radical Reduction of 14600 Mw PMMA-ttc in DMAC, Adding Luperox® 26 Over 5.2 Hours

A 3-necked round bottom flask was fitted with an overhead stirring assembly, internal thermocouple, reflux condenser, syringe pump feed system, and N₂ inlet. A sample of 14600 Mw PMMA-ttc prepared as described above (25.0 g; estimated as 2.17 mmol trithiocarbonate) was dissolved in DMAC (27.0 g) at ca. 75-80° C. The 48 wt % solids mixture was cooled to ca. 40-50° C. and treated with triethylammonium hypophosphite (1.82 g, 10.9 mmol) and mixed well. The syringe was charged with a solution of Luperox® 26 (0.155 g, 0.717 mmol) in DMAC (1.77 g). The solution was purged with nitrogen for 20 min, heated in an oil bath maintained at 90° C., and treated with the solution of Luperox® 26 over a 5.2 hr period.

The colorless reaction mass was diluted with MEK (50 mL) and treated slowly with methanol (750 mL) to precipitate the product. The liquid phase was removed with a fritted dip tube, and product was re-precipitated using MEK/MeOH. Filtration and drying provided 17.8 g of white powder.

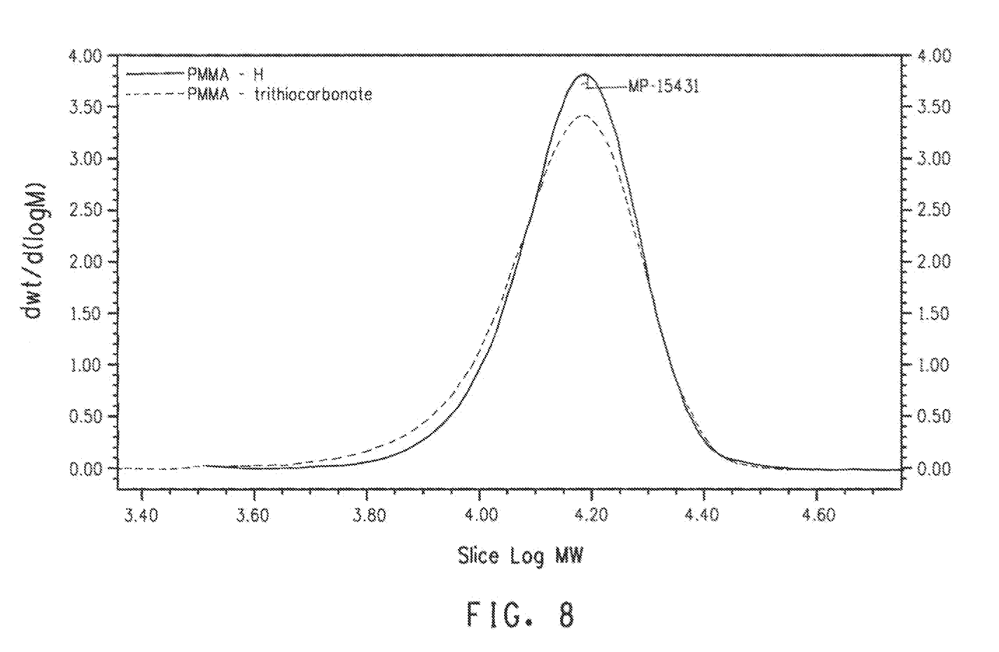

SEC (vs. PMMA standards): Mw=15110, Mn=14130, Mz=16090, MP=15430, PD=1.07. An SEC overlay, as shown in FIG. 8, indicates that a portion of lower molecular weight material present in the as-prepared 14600 Mw PMMA was removed by the precipitation processes.

UV (THF, 1.00 g/L, 1 cm): A₃₁₂=0.00. Conversion of trithiocarbonate>99.9%.

### Example 7

### 25000 Mw PMMA-ttc Via RAFT Polymerization

A 3-necked flask fitted with an addition funnel, condenser, and N₂ inlet, a thermocouple, and an overhead stirrer assembly was charged with trithiocarbonate RAFT agent C₁₂H₂₅SC(S)SC(CH₃)(CN)CH₂CH₂CO₂CH₃ (3.26 g, 7.82 mmol) and MEK (80 mL). Initiator (V-601, FW=230.26, 180 mg, 0.782 mmol; [RAFT]/[initiator]=10) was added. The addition funnel was charged with MMA (200 g) in MEK (80 mL). A 10.0 ml portion of MMA monomer solution was added, and the reaction vessel was purged with N₂ for 20 min. The temperature was increased to 75° C. The remaining monomer solution was fed over 1.5 hr. Heating was continued for an additional 21 hr.

¹H NMR (CDCl₃) showed conversion was 69.4%. The solution was diluted with MEK (70 mL), then added to methanol (3 L) to precipitate the polymer. A solid was collected, and dried to give 141.6 g of product.

SEC (vs PMMA standards): Mw=25025, Mn=21930, Mz=27550, MP=27650, PD=1.14.

### Radical Reduction of 25000 Mw PMMA-ttc in DMAC, Adding Luperox® 26 Over 4.125 Hours

A 3-necked round bottom flask was fitted with an overhead stirring assembly, internal thermocouple, reflux condenser, syringe pump feed system, and N₂ inlet. A sample of 25000 Mw PMMA-ttc prepared as described above (25.0 g; estimated as 1.38 mmol trithiocarbonate) was dissolved in DMAC (27.0 g) at ca. 75-80° C. to give a 48 wt % solids solution. The mixture was cooled to ca. 40-50° C. and treated with triethylammonium hypophosphite (1.15 g, 6.9 mmol) and mixed well. A syringe was charged with a solution of Luperox® 26 (0.123 g, 0.569 mmol) in DMAC (1.40 g). The solution was purged with nitrogen for 20 min, heated in an oil bath maintained at 90° C., and treated with the solution of Luperox® 26 over a 4.125 hr period.

The colorless reaction mass was diluted with methyl ethyl ketone (MEK, 50 mL) and treated slowly with methanol (MeOH, 750 mL) to precipitate the product. The liquid phase was removed with a fritted dip tube, and product was re-precipitated using MEK/MeOH. Filtration and drying provided 20.6 g of white powder.

SEC (vs. PMMA standards): Mw=25640, Mn=23070, Mz=27930, MP=27720, PD=1.11.

UV (THF, 1.00 g/L, 1 cm): A₃₁₂=0.00, indicating conversion of trithiocarbonate>99.9%.

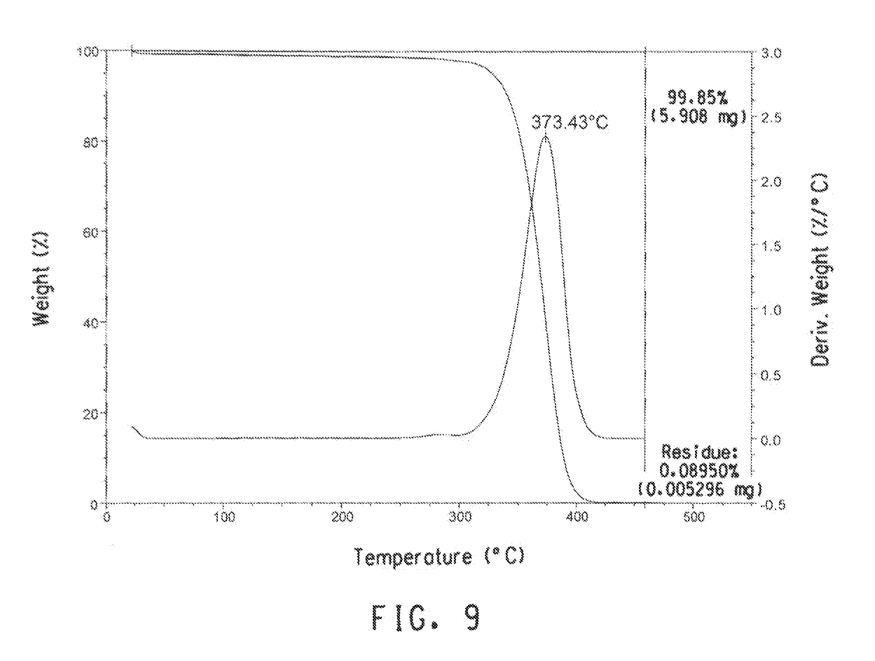

FIG. 9 shows the TGA graph for this sample.

### Comparative Example G

### Radical Reduction of 25000 Mw PMMA-ttc in MEK, at Low Solids, and a Precharge of LuDerox® 26

A 3-necked round bottom flask was fitted with a stir bar, internal thermocouple, reflux condenser, and N₂ inlet. A sample of 25000 Mw PMMA-ttc prepared as described above (5.0 g; estimated as 0.276 mmol trithiocarbonate) was dissolved in MEK (23.0 g, 17.9 wt % solids). Triethylammonium hypophosphite (0.230 g, 1.38 mmol) was added and mixed well. Luperox® 26 (0.030 g, 0.139 mmol) in MEK (1 g) was added. The solution was purged with N₂ for 20 min, and heated in an oil bath maintained at 90° C. Heating was continued for 6.5 hr. Color diminished gradually, and was completely gone after ca.6 hr.

The homogeneous solution was cooled and treated slowly with methanol (375 mL) to precipitate the product. The liquid phase was removed with a fritted dip tube, and product was re-precipitated (inverse) using MEK/MeOH. Filtration and drying provided 4.41 g of white powder.

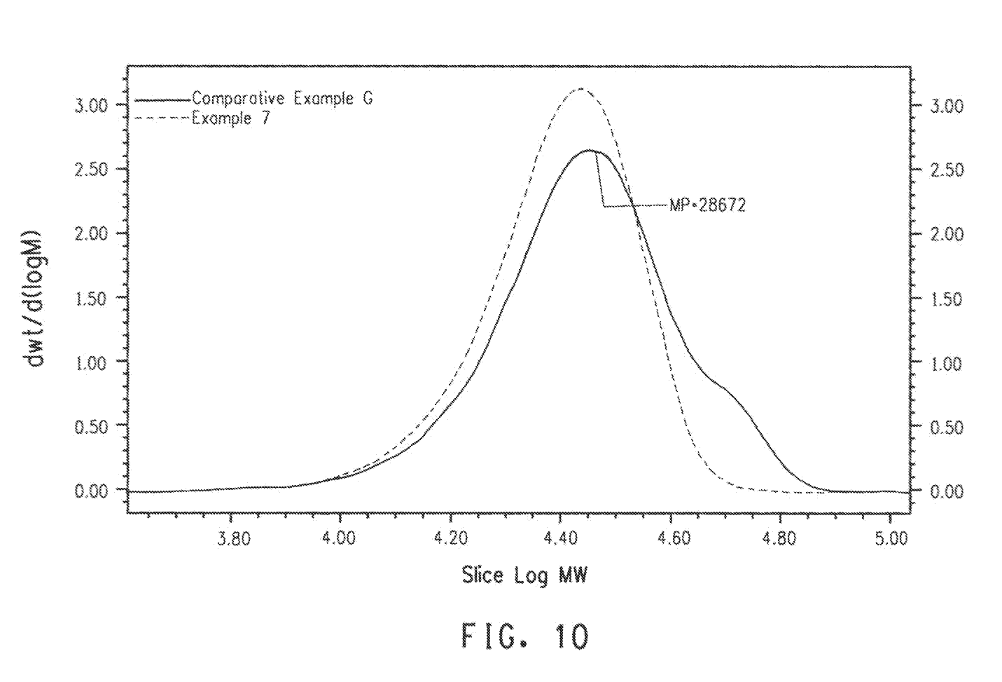

SEC (vs. PMMA standards): Mw=29260, Mn=25230, Mz=33390, MP=28670, PD=1.16. A distinct high molecular weight shoulder is apparent in FIG. 10.

UV (THF, 1.00 g/L, 1 cm): A₃₁₂=0.00, indicating conversion of trithiocarbonate>99.9%.

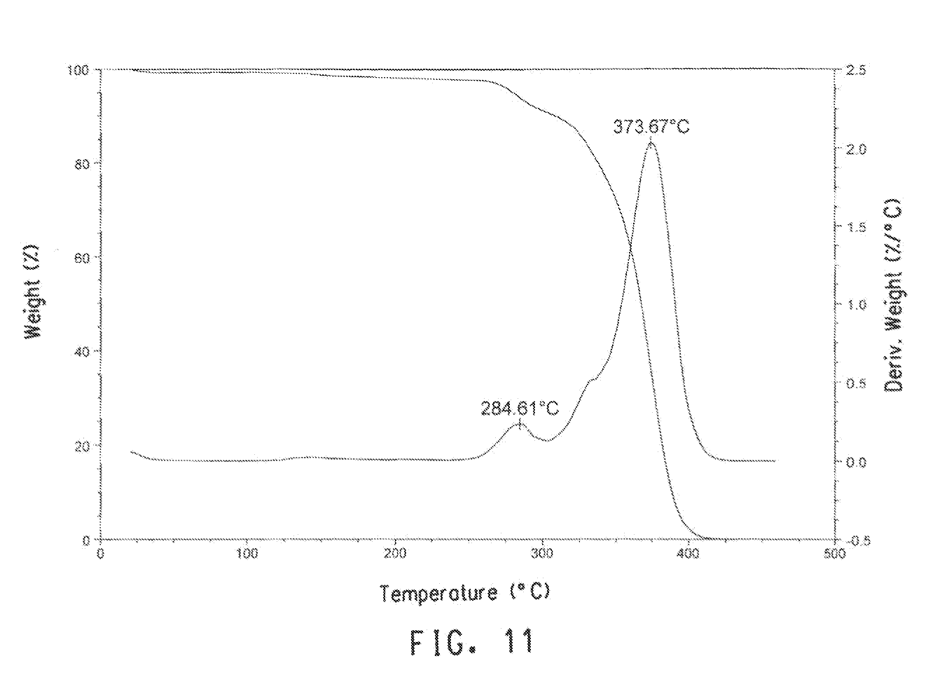

FIG. 11 shows the TGA graph for this sample. Compared to FIG. 9, there is considerably more material that is thermally unstable below 300° C.

What is claimed is:

1. A process comprising:
a) forming a homogeneous solution comprising:
i) a first solvent;
ii) a salt of hypophosphorous acid, M⁺H₂PO₂, wherein M⁺ is a protonated nitrogen base or tetra-alkyl ammonium;
iii) 25-80 wt % of a polymer comprising a sulfur-containing functional group, —CHY—SC(S)X or —C(Me)Z—SC(S)X, wherein the wt % polymer is based on the combined weight of the polymer and the first solvent, and
wherein
X is R, OR¹, N(R²)₂, SR³, or P(O)(OR⁴)₂;
Y is —CN, aryl, carboxyl, or C(O)NHR⁵;
Z is —CN, carboxyl, or C(O)NHR⁵;
R is substituted or unsubstituted C₁-C₂₅ alkyl; substituted or unsubstituted C₂-C₂₅ alkenyl; substituted or unsubstituted C₂-C₂₅ alkynyl; substituted or unsubstituted phenyl; substituted or unsubstituted naphthyl; and substituted or unsubstituted benzyl;
R¹, R², R³, and R⁴ are substituted or unsubstituted C₁-C₂₅ alkyl; substituted or unsubstituted C₆-C₁₀ aryl; a 3- to 8-membered carbocyclic or heterocyclic ring, or N(R²)₂ is a 3- to 8-membered heterocyclic ring; and
R⁵ is C₁-C₆ alkyl or substituted alkyl; and
iv) a radical initiator;
b) heating the homogeneous solution to a reaction temperature for a sufficient time to replace the —SC(S)X groups of the functional groups by —H; and
wherein the radical initiator has a half-life of more than 2 hours at the reaction temperature and the molar ratio of radical initiator to sulfur-containing functional group is 1:1 or less.

2. The process of claim 1, wherein the initiator is selected from the group consisting of peroxy esters, and alkanoyl peroxides.

3. The process of claim 1, wherein M⁺ is a protonated trialkylamine.

4. The process of claim 3, wherein M⁺ is selected from the group consisting of (HNEt₃)+, (HNPr₃)+, and (HNBu₃)+.

5. The process of claim 1, wherein the molar ratio of salt of the hypophosphorous acid to the functional group is greater than 3.

6. The process of claim 1, wherein the polymer is a homopolymer selected from the group of polystyrenes, polyacrylates and polymethacrylates.

7. The process of claim 1, wherein the polymer is a copolymer comprising repeat units selected from the group consisting of styrenes, acrylates, and methacrylates.

8. The process of claim 1, wherein the first solvent comprises at least one of DMAC, MPK, MEK, and THF.

9. The process of claim 1, wherein the polymer is first dissolved in the first solvent and then the salt of the hypophosphorous acid is added.

10. The process of claim 1, further comprising:
c) isolating a polymer from the solution.

11. The process of claim 10, wherein the isolated polymer contains less than 2 wt % of a coupled product.

12. A process comprising:
a) forming a homogeneous solution comprising:
i) a first solvent;
ii) a salt of hypophosphorous acid, M⁺H₂PO₂, wherein M⁺ is a protonated nitrogen base or tetra-alkyl ammonium;
iii) 25-80 wt % of a polymer comprising a sulfur-containing functional group, —CHY—SC(S)X or —C(Me)Z—SC(S)X, wherein the wt % polymer is based on the combined weight of the polymer and the first solvent, and
wherein
X is R, OR¹, N(R²)₂, SR³, or P(O)(OR⁴)₂;
Y is —CN, aryl, carboxyl, or C(O)NHR⁵;
Z is —CN, carboxyl, or C(O)NHR⁵;
R is substituted or unsubstituted C₁-C₂₅ alkyl; substituted or unsubstituted C₂-C₂₅ alkenyl; substituted or unsubstituted C₂-C₂₅ alkynyl; substituted or unsubstituted phenyl; substituted or unsubstituted naphthyl; and substituted or unsubstituted benzyl;
R¹, R², R³, and R⁴ are substituted or unsubstituted C₁-C₂₅ alkyl; substituted or unsubstituted C₆-C₁₀ aryl; a 3- to 8-membered carbocyclic or heterocyclic ring, or N(R²)₂ is a 3- to 8-membered heterocyclic ring; and
R⁵ is C₁-C₆ alkyl or substituted alkyl;
b) adding a radical initiator to the homogeneous solution,
c) heating the homogeneous solution to a reaction temperature for a sufficient time to replace the —SC(S)X groups of the functional groups by —H; and
wherein the radical initiator is added to the homogeneous solution over a period of at least 3 half-lives at the reaction temperature and wherein the molar ratio of radical initiator to sulfur-containing functional group is 1:1 or less.

13. The process of claim 12, wherein the polymer, the salt of the hypophosphorous acid are dissolved in the first solvent, and the radical initiator is added in 1-10 portions

14. The process of claim 13, wherein the radical initiator is dissolved in a second solvent.

15. The process of claim 12, wherein the initiator is selected from the group consisting of peroxy esters and alkanoyl peroxides.

16. The process of claim 12, wherein M⁺ is a protonated trialkylamine.

17. The process of claim 16, wherein M⁺ is selected from the group consisting of (HNEt₃)+, (HNPr₃)+, and (HNBu₃)+.

18. The process of claim 12, wherein the molar ratio of salt of the hypophosphorous acid to the functional group is greater than 3.

19. The process of claim 12, wherein the polymer is a homopolymer selected from the group consisting of polystyrenes, polyacrylates and polymethacrylates.

20. The process of claim 12, wherein the polymer is a copolymer comprising repeat units selected from the group consisting of styrenes, acrylates, and methacrylates.

21. The process of claim 12, wherein the first solvent comprises at least one selected from the group consisting of DMAC, MPK, MEK, and THF.

22. The process of claim 12, wherein the polymer is first dissolved in the first solvent and then the salt of the hypophosphorous acid is added.

23. The process of claim 12, further comprising:
c) isolating a polymer from the solution.

24. The process of claim 23, wherein the isolated polymer contains less than 2 wt % of a coupled product.
